(19) United States
(12) Patent Application Publication
(10) Pub. No.: US 2025/0015508 A1
(43) Pub. Date: Jan. 9, 2025

(54) REFLECT ARRAY

(71) Applicant: Japan Display Inc., Tokyo (JP)

(72) Inventors: Daiichi SUZUKI, Tokyo (JP); Takanori TSUNASHIMA, Tokyo (JP); Masayuki IKARI, Tokyo (JP); Shinichiro OKA, Tokyo (JP); Mitsutaka OKITA, Tokyo (JP); Kazuki MATSUNAGA, Tokyo (JP)

(73) Assignee: Japan Display Inc., Tokyo (JP)

(21) Appl. No.: 18/893,986

(22) Filed: Sep. 24, 2024

Related U.S. Application Data
(63) Continuation of application No. PCT/JP2023/001964, filed on Jan. 23, 2023.

(30) Foreign Application Priority Data
Mar. 25, 2022 (JP) 2022-050468

(51) Int. Cl. H01Q 15/14

(52) U.S. Cl. CPC H01Q 15/14

(57) ABSTRACT

A reflect array includes a plurality of patch electrodes arranged spaced apart and interconnected to an incident surface of a radio wave, a plurality of control electrodes arranged spaced apart to correspond to the plurality of patch electrodes and disposed on a rear side of the plurality of patch electrodes, a liquid crystal layer between the plurality of patch electrodes and the plurality of control electrodes, and an auxiliary electrode disposed to overlap a separated region of the plurality of control electrodes.

### CROSS-REFERENCE TO RELATED APPLICATIONS

This application is a Continuation of International Patent Application No. PCT/JP2023/001964, filed on Jan. 23, 2023, which claims the benefit of priority to Japanese Patent Application No. 2022-050468, filed on Mar. 25, 2022, the entire contents of each are incorporated herein by reference.

### FIELD

An embodiment of the present invention relates to a reflect array using liquid crystal materials.

### BACKGROUND

A reflect array has a function of reflecting incident waves in a desired direction and is used, for example, to reflect radio waves in a zone where radio waves are difficult to reach in between high-rise buildings (blind zone). A reflect array in which a patch electrode and a metal reflector are installed across a substrate composed of dielectric material is disclosed (refer to Japanese Unexamined Patent Application Publication No. 2012-049931).

Using liquid crystals as the dielectric material in reflect arrays makes it possible to vary the directivity of the reflected wave because the dielectric constant of the liquid crystals varies with voltage. The reflect array using liquid crystals is expected to further improve the reflective properties of the reflect array.

### SUMMARY

A reflect array in an embodiment according to the present invention includes a plurality of patch electrodes arranged spaced apart and interconnected to an incident surface of a radio wave, a plurality of control electrodes arranged spaced apart to correspond to the plurality of patch electrodes and disposed on a rear side of the plurality of patch electrodes, a liquid crystal layer between the plurality of patch electrodes and the plurality of control electrodes, and an auxiliary electrode disposed to overlap a separated region of the plurality of control electrodes.

### BRIEF DESCRIPTION OF DRAWINGS

FIG. 1A is a plan view of a reflect array according to an embodiment of the present invention.

FIG. 1B is a cross-sectional view corresponding to A-B shown in the plan view of the reflect array according to an embodiment of the present invention.

FIG. 2A is a plan view of a unit cell configuring a reflect array according to an embodiment of the present invention.

FIG. 2B is a cross-sectional view corresponding to C-D shown in the plan view of the unit cell configuring the reflect array according to an embodiment of the present invention.

FIG. 3A is an illustration of the operation of a unit cell configuring a reflect array according to an embodiment of the present invention and shows a state in which a bias voltage is not applied to a liquid crystal layer.

FIG. 3B is an illustration of the operation of a unit cell configuring a reflect array according to an embodiment of the present invention and shows a state in which a bias voltage is applied to a liquid crystal layer.

FIG. 4 is a schematic illustration of a change in the direction of travel of the reflected wave by a reflect array according to an embodiment of the present invention.

FIG. 5A is a cross-sectional view of a reflect array according to an embodiment of the present invention.

FIG. 5B is a cross-sectional view of a reflect array according to an embodiment of the present invention.

FIG. 6A is a plan view of a reflect array according to an embodiment of the present invention.

FIG. 6B is a cross-sectional view corresponding to E-F shown in the plan view of the reflect array according to an embodiment of the present invention.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements like those described previously with respect to previous drawings may be given the same reference sign (or a number followed by A, B, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

### First Embodiment

The reflect array according to the present embodiment includes a patch electrode (common electrode) and a control electrode arranged across a liquid crystal layer used as a dielectric layer, and an auxiliary electrode for high-frequency conduction is disposed on the control electrode side. The details are described below with reference to the drawings.

### 1.1 Reflect Array

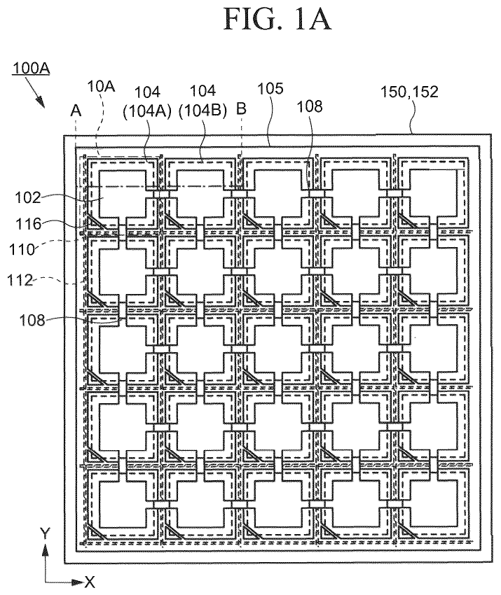

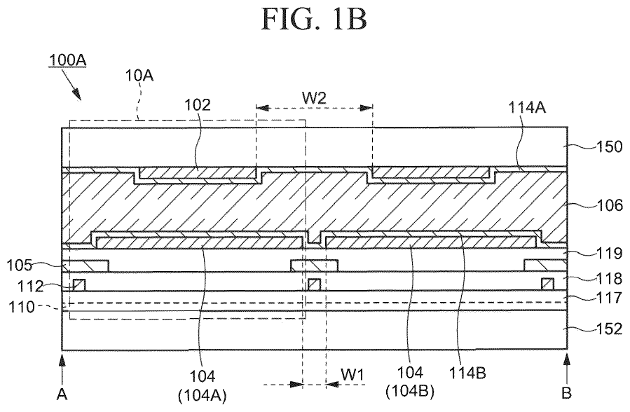

FIG. 1A shows a plan view of the reflect array 100A according to the present embodiment, and FIG. 1B shows a cross-sectional structure corresponding to A-B shown in the plan view. The following description will refer to both FIG. 1A and FIG. 1B as appropriate.

The reflect array 100A includes at least one patch electrode (common electrode) 102, at least one control electrode 104, an auxiliary electrode 105, and a liquid crystal layer 106. The patch electrode (common electrode) 102 is arranged on a first surface of a first substrate 150, and the control electrode 104 and the auxiliary electrode 105 are arranged on a first surface of a second substrate 152. The first surface of the first substrate 150 and the first surface of the second substrate 152 are arranged to face each other, and the liquid crystal layer 106 is disposed therebetween. That is, the reflect array 100A has a structure in which the patch electrode (common electrode) 102, the control electrode 104, and the auxiliary electrode 105 are arranged to face each other with the liquid crystal layer 106 therebetween.

As shown in FIG. 1A, the patch electrode (common electrode) 102 is rectangular in shape in a plan view. A length of one side of the patch electrode (common electrode) 102 is set appropriately according to the frequency of the reflected radio wave. The patch electrodes (common electrodes) 102 are arranged in a matrix on the first surface of the first substrate 150 in an X-axis and a Y-axis direction shown in FIG. 1A. Adjacent patch electrodes (common electrodes) 102 are interconnected by a common wiring 108.

The X-axis and Y-axis directions shown in FIG. 1A are used for illustrative purposes the X-axis and Y-axis directions may be read as a first direction and a second direction that intersects the first direction.

The control electrodes 104 are arranged to overlap the patch electrodes (common electrodes) 102 in a plan view. The control electrodes 104 are arranged in a matrix on the second surface of the second substrate 152 in the X-axis and Y-axis directions shown in FIG. 1A, corresponding to the arrangement of the patch electrodes (common electrodes) 102. The control electrodes 104 are electrodes whose applied voltage is individually and independently controlled and are arranged with a gap between adjacent electrodes.

The auxiliary electrode 105 is arranged on the back side of the control electrode 104, that is, on an opposite side of the control electrode 104 from the liquid crystal layer 106 (in other words, a side opposite to the side facing the patch electrode (common electrode) 102). The auxiliary electrode 105 is arranged so that it overlaps a region where the control electrodes are separated from each other in the arrangement of the control electrodes 104 in the X-axis and Y-axis directions. In other words, the auxiliary electrode 105 is disposed to be exposed in a region where the patch electrodes (common electrode) 102 are separated in a plan view. With this arrangement of electrodes, when the reflect array 100A is viewed in a plan view, it is arranged so that a back surface of the patch electrode (common electrode) 102 is covered by the control electrode 104 and the auxiliary electrode 105, with the liquid crystal layer 106 in between.

The reflect array 100A has a function of reflecting radio waves incident on the incident surface in a predetermined direction. The first substrate 150 is arranged on an incident side of the radio wave, and the second substrate 152 is arranged on a back side of the incident side. In other words, the patch electrode (common electrode) 102 is arranged on the incident side of the radio wave, and the control electrode 104 is arranged across the liquid crystal layer 106 on the back side.

The reflect array 100A is configured as a basic unit, which consists of a set of patch electrodes (common electrodes) 102, a liquid crystal layer 106, and a control electrode 104, and an auxiliary electrode 105 which are stacked (which may also include the first substrate 150 and the second substrate 152). Hereafter, this basic unit will be referred to as a unit cell 10A.

As shown in FIG. 1A, the reflect array 100A, selection signal lines 110 extending in the X-axis direction, and control signal lines 112 extending in the Y-axis direction are arranged. The selection signal lines 110 and the control signal lines 112 are disposed to intersect each other through an insulating layer. For example, as shown in FIG. 1B, a first insulating layer 117 and a second insulating layer 118 are disposed on the second substrate 152, and the selection signal lines 110 (shown as dotted lines) and the control signal lines 112 are disposed across the first insulating layer 117.

As shown in FIG. 1A, switching elements 116 are arranged in the X-axis and Y-axis directions corresponding to the control electrodes 104. The switching elements 116 are controlled in a switching operation (on/off state) by a selection signal of the selection signal lines 110. Each of the switching elements 116 operate so that the control signal (control voltage) is applied to the control electrode 104 by conducting the control signal line 112 and the control electrode 104 when it is on. Each of the switching elements 116 allow control signals (control voltages) to be applied individually to the control electrodes 104 arranged in a matrix.

The auxiliary electrode 105 is disposed overlapping the selection signal lines 110 and the control signal lines 112 across the insulating layer. For example, as shown in FIG. 1B, the auxiliary electrode 105 is disposed on the second insulating layer 118 covering the control signal line 112. A third insulating layer 119 is disposed to insulate the control electrode 104 and the auxiliary electrode 105. FIG. 1B shows a structure in which the control electrode 104 is arranged on an upper layer of the third insulating layer 119 and the auxiliary electrode 105 is arranged on a lower layer. The third insulating layer 119 prevents a short circuit between the auxiliary electrode 105 and the control electrode 104, and also allows one of the outer edges of the control electrode 104 to overlap with the auxiliary electrode 105 in a plan view.

FIG. 1A and FIG. 1B show a form in which the auxiliary electrode 105 is partially disposed on the lower layer side of the control electrode 104. The auxiliary electrode 105 is not limited to the form illustrated and may be disposed over the entire lower layer side of the control electrode 104. The auxiliary electrode 105 may be grounded or may be applied with a predetermined voltage applied. The auxiliary electrode 105 may be floating.

With this multilayer structure, it is possible to arrange the spacing of the control electrodes 104 on the second substrate 152 as narrow as possible without being affected by the selection signal lines 110 and control signal lines 112. For example, FIG. 1B shows a first control electrode 104A and a second control electrode 104B as control electrodes 104, and an interval W1 between these two control electrodes can be narrower than the adjacent interval W2 between the patch electrodes (common electrodes) 102 (W1<W2). The auxiliary electrode 105 is arranged in a region adjacent to the first control electrode 104A and the second control electrode 104B and has a width wider than the interval W1 to ensure that the gap in the region where the control electrodes are arranged can be filled.

As shown in FIG. 1B, a first alignment film 114A is disposed on the first substrate 150 and a second alignment film 114B is disposed on the second substrate 152. The first alignment film 114A is disposed to cover the patch electrode (common electrode) 102, and the second alignment film 114B is disposed to cover the control electrode 104. The first alignment film 114A and the second alignment film 114B are disposed to control an alignment state of the liquid crystal layer 106. The liquid crystal layer 106 includes elongated rod-shaped liquid crystal molecules. The liquid crystal molecules are controlled in their initial alignment state (alignment state in the absence of an electric field) by the first alignment film 114A and the second alignment film 114B.

The alignment state of the liquid crystal molecules in the liquid crystal layer 106 is changed by the potential difference between the patch electrode (common electrode) 102 and the control electrode 104. The patch electrode (common electrode) 102 is set to a constant potential in the reflect array 100A, and the control signal (control voltage) applied to the control electrode 104 is individually controlled. The reflect array 100A can be regarded as a set of unit cells 10A. Since the unit cell 10A includes the switching element 116, the control signal (control voltage) applied to the control electrode 104 can be individually controlled for each individual unit cell. Therefore, the alignment state of the liquid crystal molecules in the liquid crystal layer 106 can be individually controlled for each unit cell 10A. As the dielectric constant changes when the alignment state of the liquid crystal molecules changes, the phase of the reflected radio wave can be made different for each unit cell 10A.

The dielectric constant of the liquid crystal layer 106 changes with the alignment state of the liquid crystal molecules. The phase of radio waves reflected by the reflect array 100A varies with the dielectric constant of liquid crystal layer 106. Therefore, the control signal (control voltage) applied to the control electrodes 104 arranged in a matrix can generate a phase difference in the radio waves reflected in the plane of the reflect array 100A and control the direction of travel of the reflected waves.

The reflect array 100A reflects incident waves on the surface where the patch electrode (common electrode) 102 is arranged, so the patch electrode (common electrode) 102 is also called a reflector. The unit cell 10A can also be regarded as a patch antenna with patch electrodes (patch electrodes (common electrodes) 102) on the top surface of a dielectric (liquid crystal layer 106) and reflective electrodes (control electrodes 104) on the back surface, the reflect array 100A can also be called a reflect array antenna.

Since the control electrode 104 has a function as a reflector (in other words, since it corresponds to the ground plane of the reflect array), it is desirable that the distance between adjacent control electrodes is as narrow as possible. However, to use the control electrodes 104 as individual electrodes and to insulate them from adjacent control electrodes and prevent mutual interference, it is necessary to arrange them spaced apart at a predetermined interval. This would result in a decrease in the area as a reflector and would not provide sufficient reflective characteristics.

On the other hand, the reflection array 100A according to the present embodiment is disposed with the auxiliary electrode 105, so that even if the control electrodes 104 are spaced apart from each other, the decrease in the area of the reflection plate can be compensated. Although the third insulating layer 119 is interposed between the auxiliary electrode 105 and the control electrode 104, it can be regarded as a single conductive surface in terms of high frequency, allowing a sufficient high-frequency current to flow when radio waves are incident on it. Since the liquid crystal molecules do not follow the frequency of the radio waves reflected by the reflect array 100A, while applying a voltage to control the alignment of the liquid crystal molecules to the control electrode 104, the configuration of the control electrode 104 and auxiliary electrode 105 makes it possible to form a reflective surface on the back side of the patch electrode (common electrode) 102 and to sufficiently flow high-frequency current when radio waves are incident.

Although not shown in FIG. 1A and FIG. 1B, the second substrate 152 may be disposed with a driver circuit that outputs a selection signal to the selection signal lines 110 and a bias signal to the control signal lines 112. Input terminals may be disposed to input signals and drive power to drive these driver circuits.

### 1-2. Unit Cell

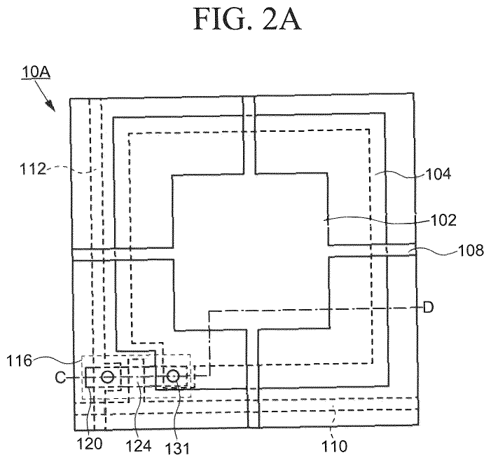

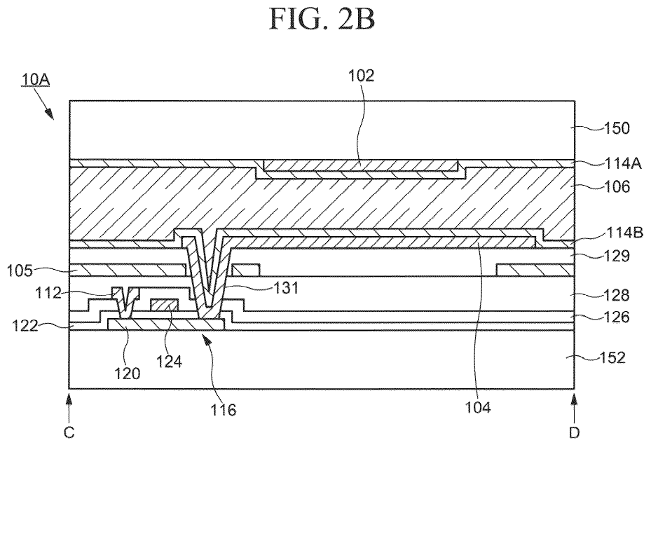

FIG. 2A and FIG. 2B show details of the unit cell 10A configuring the reflecting device 100A. FIG. 2A shows a plan view of the unit cell 10A, and FIG. 2B shows a cross-sectional structure of a section between C and D shown in FIG. 2A. As shown in FIG. 2A and FIG. 2B, the unit cell 10A is arranged so that the common electrode 102, the liquid crystal layer 106, and the control electrode 104 overlap in a plan view.

The patch electrode (common electrode) 102 shown in FIG. 2A has a shape that is targeted for the vertical and horizontal polarization of the incoming radio wave, specifically a square. A size (vertical and horizontal dimensions) of the patch electrode (common electrode) 102 is set appropriately according to the frequency of the target radio wave. The shape of the patch electrode (common electrode) 102 is not limited to a square but may be rectangular or have other geometric shapes.

The patch electrode (common electrode) 102 is connected to a common wiring 108. There is no limitation in the connection structure between the common wiring 108 and the patch electrode (common electrode) 102, for example, the common wiring 108 and the patch electrode (common electrode) 102 are formed with the same conductive layer. The common wiring 108 is connected to a power circuit not shown. Alternatively, the common wiring 108 is grounded or connected to grounded wiring. It is possible to control the patch electrodes (common electrodes) 102 arrayed in a matrix to a predetermined potential by interconnecting the patch electrodes (common electrodes) 102 with the common wiring 108.

The control electrode 104 in the unit cell 10A has a function of controlling the alignment state of the liquid crystal layer 106 as well as a function as a reflector. As shown in FIG. 2A, the control electrode 104 has a larger area than the patch electrode (common electrode) 102. The control electrode 104 and the patch electrode (common electrode) 102 overlap and the patch electrode (common electrode) 102 is arranged in a region inside the control electrode 104.

Furthermore, the auxiliary electrode 105 is disposed to surround the peripheral portion of the control electrode 104. The auxiliary electrode 105 may be arranged to overlap the peripheral portion of the control electrode 104 in a plan view to eliminate gaps. The auxiliary electrode 105 may be sized to spread over the entire unit cell 10A. When viewed in reflect array 100A, it may have a size that extends over the entire reflect array. The control electrode 104 is connected to the switching element 116 on the lower layer side in a contact hole 131. The auxiliary electrode 105 is disposed so that it does not overlap the contact hole 131 so that it does not short-circuit with the control electrode 104 at the contact hole 131. For example, the auxiliary electrode 105 is disposed with an opening larger than the contact hole 131 in the region where the contact hole 131 is disposed.

The switching element 116, the selection signal line 110, and the control signal line 112 are disposed on the second substrate 152. The switching element 116 connects the control signal line 112 to the control electrode 104. The switching operation (on/off operation) of the switching element 116 is controlled by the selection signal of the selection signal line 110.

The control electrode 104 is connected to the control signal line 112 via the switching element 116. FIG. 2A and FIG. 2B show an example in which the switching element 116 is formed by a transistor. The transistor has a structure in which a semiconductor layer 120, a gate insulating layer 122, and a gate electrode 124 are stacked. A first interlayer insulating layer 126 is disposed above the gate electrode 124, and the control signal line 112 is disposed thereon. A second interlayer insulating layer 128 is disposed above the switching element 116 and the control signal line 112. The auxiliary electrode 105 is disposed above the second interlayer insulating layer 128. The gate electrode 124 of the switching element (transistor) 116 is connected to the selection signal line 110, one of the input/output terminals (source or drain) is connected to the control signal line 112, and the other is connected to the control electrode 104.

A planarization layer 129 is disposed above the auxiliary electrode 105. The control electrode 104 is disposed on top of the planarization layer 129. The control electrode 104 is connected to the switching element 116 by the contact hole 131 that passes through the planarization layer 129, the second interlayer insulating layer 128, the first interlayer insulating layer 126, and the gate insulating layer 122.

The control electrode 104 is connected to the control signal line 112 via the switching element 116, and the potential of the control electrode 104 is individually controlled. The selection signal line 110, control signal line 112, and switching element 116, which are disposed on the lower layer side of the control electrode 104, are embedded by the second interlayer insulating layer 128 and planarization layer 129. Since the control electrode 104 is disposed above the planarization layer 129, it is separated from the auxiliary electrode 105 and can be made larger without being affected by the selection signal line 110, control signal line 112, and switching element 116.

The alignment state of the liquid crystal molecules in the liquid crystal layer 106 is controlled by the control electrode 104. In other words, the alignment state of the liquid crystal molecules in the liquid crystal layer 106 is controlled by the bias signal applied to the control electrode 104. The bias signal is a DC voltage signal or a polarity-reversing DC voltage signal in which positive and negative DC voltages are alternately reversed.

The liquid crystal layer 106 is formed of a liquid crystal material having dielectric anisotropy. For example, nematic, smectic, cholesteric, and discotic liquid crystals can be used as liquid crystal materials to form liquid crystal layer 106. The dielectric constant of the liquid crystal layer 106 changes depending on the alignment state of the liquid crystal molecules. The alignment state of the liquid crystal molecules is controlled by the control electrode 104. When the incident wave is reflected in the unit cell 10A, the phase of the reflected wave changes according to the dielectric constant of the liquid crystal layer 106.

The frequency bands to which the reflect array 100A is applicable are the very short wave (VHF) band, ultra short wave (UHF) band, microwave (SHF) band, submillimeter wave (THF), millimeter wave (EHF) band, and terahertz wave band. The alignment of the liquid crystal molecules in the liquid crystal layer 106 changes with the bias voltage applied to the control electrode 104, but it hardly follows the frequency of the radio waves incident on the patch electrode (common electrode) 102. These characteristics of the liquid crystal molecules allow the control electrode 104 to change the dielectric constant of the liquid crystal layer 106 while reflecting radio waves at the patch electrode (common electrode) 102 and controlling the phase of the reflected radio waves.

The first substrate 150 and second substrate 152 are formed of glass, quartz, or other materials. The second substrate 152 may also be formed of a dielectric material such as resin. Each layer on the first substrate 150 and the second substrate 152 is formed using the following materials. The semiconductor layer 120 is formed of silicon semiconductors such as amorphous silicon and polycrystalline silicon, and oxide semiconductors including metal oxides such as indium oxide, zinc oxide, and gallium oxide. The gate insulating layer 122 and the first interlayer insulating layer 126 are formed of inorganic insulating materials such as, for example, silicon oxide, silicon nitride, and silicon nitride oxide. The selection signal line 110 and the gate electrode 124 are configured, for example, of molybdenum (Mo), tungsten (W), or alloys thereof. The control signal line 112 is formed using a metallic material such as titanium (Ti), aluminum (Al), or molybdenum (Mo). For example, the control signal line 112 is configured with a titanium (Ti)/aluminum (Al)/titanium (Ti) laminated structure or a molybdenum (Mo)/aluminum (Al)/molybdenum (Mo) laminated structure. The second interlayer insulating layer 128 is formed of inorganic insulating materials such as silicon oxide, silicon nitride, and silicon nitride oxide, or resin materials such as acrylic and polyimide. The planarization layer 129 is formed of a resin material such as acrylic, polyimide, and the like. The patch electrode (common electrode) 102, the control electrode 104, and the auxiliary electrode 105 are formed of a metal film such as aluminum (Al), copper (Cu), or a transparent conductive film such as indium tin oxide (ITO).

Although not shown in FIG. 2B, the first substrate 150 and the second substrate 152 are attached by a sealant across the liquid crystal layer 106. The liquid crystal layer 106 is sealed within the region enclosed by the first substrate 150, the second substrate 152, and the sealant. The gap between the first substrate 150 and the second substrate 152 is roughly 20 μm to 100 μm, for example, 50 μm. Although not shown, spacers may be disposed between the first substrate 150 and the second substrate 152 to keep the spacing constant.

The configuration of unit cell 10A shown in FIG. 2A and FIG. 2B is applied to the reflect array 100A in which the patch electrode (common electrode) 102 and the control electrode 104 are arranged in a matrix as shown in FIG. 1A. A control signal (control voltage) is applied to the control electrode 104 by the switching element 116, and the alignment state of the liquid crystal layer 106 is controlled for each unit cell 10A. The patch electrode (common electrode) 102 is arranged on the incident side of the radio wave, and a reflector formed by the control electrode 104 and the auxiliary electrode 105 is arranged on its back side across the liquid crystal layer 106. The auxiliary electrode 105 is disposed to fill the outer portion of the periphery of the control electrode 104, so that the area of the reflector can be apparently enlarged. In other words, the area of the reflector can be increased by adding the auxiliary electrode 105 compared to the case where only the control electrode 104 is arranged in a matrix.

It is possible to control the dielectric constant of the liquid crystal layer 106 for each unit cell 10A by having the patch electrode (common electrode) 102 controlled at a constant potential and the control electrode 104 connected to the control signal line 112 via the switching element 116 and individually controlled at a controlled potential. Thereby, the phase of the reflected wave can be controlled for each unit cell 10A. As a control signal, a signal that reverses polarity at a predetermined frequency (from several hertz to several hundred hertz) can be applied, and the degradation of the liquid crystal layer 106 can be suppressed compared to the case where a specific polarity is continuously applied.

### 1-3. Operation of Unit Cell

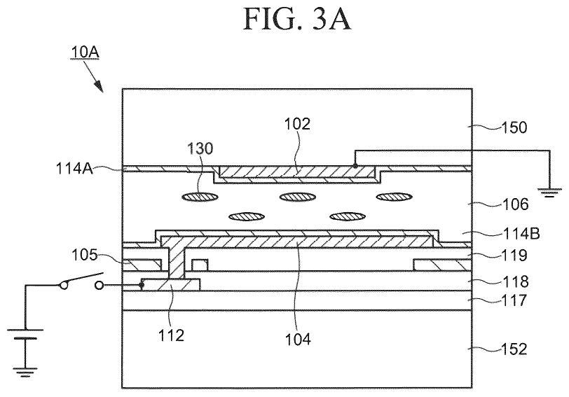

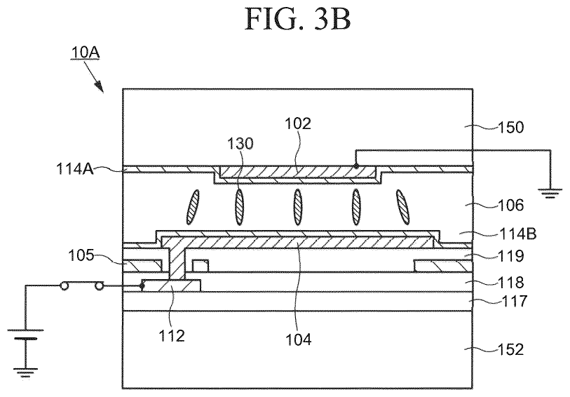

FIG. 3A and FIG. 3B show an operation of the unit cell 10A. FIG. 3A and FIG. 3B show an example where the first alignment film 114A and the second alignment film 114B are both horizontal alignment films. FIG. 3A shows a state in which a bias voltage is not applied to the control electrode 104. That is, FIG. 3A shows a state in which a DC voltage is not applied to the control electrode 104 at a level that alters the alignment state of the liquid crystal molecules. The auxiliary electrode 105 is grounded or in a floating state. This state is hereinafter referred to as the “first state”. FIG. 3A shows that in the first state, the long axis of the liquid crystal molecules 130 is horizontally aligned (initial alignment state) by the alignment regulating force of the first alignment film 114A and the second alignment film 114B. In other words, in the first state, the long axis direction of the liquid crystal molecules 130 is aligned horizontally to the surfaces of the patch electrode (common electrode) 102 and the control electrode 104.

FIG. 3B shows a state in which a bias voltage is applied to the control electrode 104 at a voltage level that alters the alignment state of the liquid crystal molecules 130. This state is hereinafter referred to as the “second state”. In the second state, the long axis direction of the liquid crystal molecules 130 aligns perpendicularly to the surfaces of the patch electrode (common electrode) 102 and the control electrode 104 under the influence of the electric field generated by the bias voltage. The angle at which the long axis of the liquid crystal molecules 130 aligns can be controlled by the magnitude of the bias signal applied to the control electrode 104 and can be aligned at an intermediate angle between horizontal and vertical.

When the liquid crystal molecules 130 have positive dielectric anisotropy, the apparent dielectric constant is larger in the second state (FIG. 3B) relative to the first state (FIG. 3A). When the liquid crystal molecules 130 have negative dielectric anisotropy, the apparent dielectric constant is smaller in the second state (FIG. 3B) relative to the first state (FIG. 3A). The liquid crystal layer 106 formed with liquid crystals having dielectric anisotropy can be regarded as a variable dielectric layer. It is possible for the unit cell 10A to control the phase of radio waves reflected at the patch electrode (common electrode) 102 to be delayed (or not) by using the dielectric anisotropy of the liquid crystal layer 106.

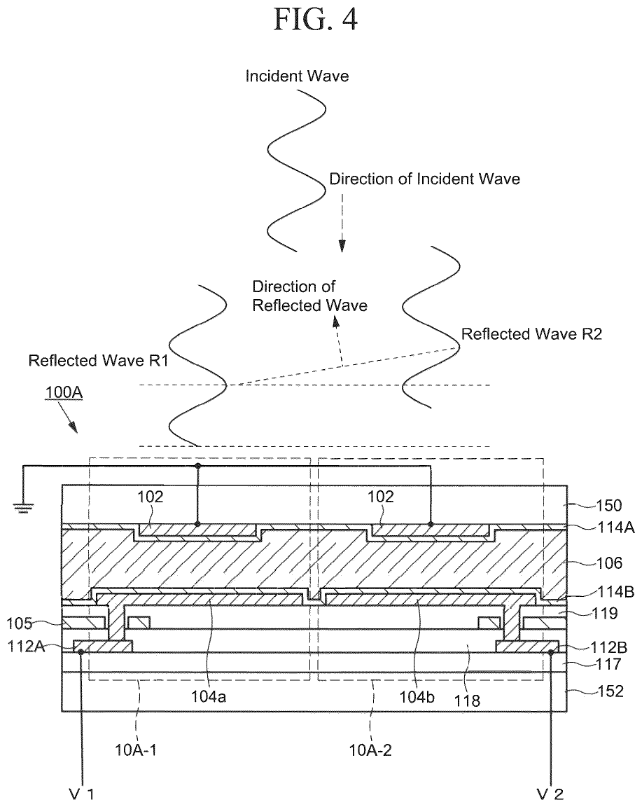

FIG. 4 schematically shows a mode in which the traveling direction of the reflected wave is changed by the first unit cell 10A-1 and the second unit cell 10A-2. A bias signal V1 is applied to the first control electrode 104A of the first unit cell 10A-1 from the control signal line 112A, and a bias signal V2 is applied to the second control electrode 104B of the second unit cell 10A-2 from the control signal line 112B. Here, the voltage levels of bias signal V1 and bias signal V2 are different (V1≠V2). The patch electrode (common electrode) 102 of the first unit cell 10A-1 and the second unit cell 10B-1 are grounded. The auxiliary electrode 105 is grounded or floating.

FIG. 4 shows a case when radio waves are incident on the first unit cell 10A-1 and the second unit cell 10A-2 at the same phase, due to different bias signals (V1+V2) being applied to the first unit cell 10A-1 and the second unit cell 10A-2, FIG. 4 schematically shows that the phase change of the reflected wave by the second unit cell 10A-2 is larger than that of the first unit cell 10A-1. As a result, the phase of the reflected wave R1 reflected by the first unit cell 10A-1 and the phase of the reflected wave R2 reflected by the second unit cell 10A-2 differ (FIG. 4 shows that the phase of the reflected wave R2 is more advanced than that of the reflected wave R1), and it appears that the direction of travel of the reflected wave changes to an oblique direction.

As shown in FIG. 4, the reflect array 100A allows the phase of the reflected wave with respect to the incident wave to be different between the first unit cell 10A-1 and the second unit cell 10A-2. FIG. 4 schematically shows a pair of unit cells, but in reality, the direction of the reflected wave can be controlled in any direction without changing the orientation of the reflect array 100A by controlling the unit cells 10A, which are arranged in a matrix, individually.

The plurality of patch electrodes (common electrodes) 102 arranged in the reflect array 100A are held at a constant potential (for example, ground potential). Since the first control electrode 104A, the second control electrode 104B, and the control signal lines 112A, 112B, which apply a bias voltage to the liquid crystal layer 106, are arranged on the back of the patch electrodes (common electrodes) 102, the electric field generated by the control signal lines 112A, 112B does not affect the front side of the reflect array 100A. In addition, the auxiliary electrode 105 is disposed to fill the gap between the first control electrode 104A and the second control electrode 104B, which apparently increases the area of the reflector. Therefore, the gain of the reflected radio waves can be improved.

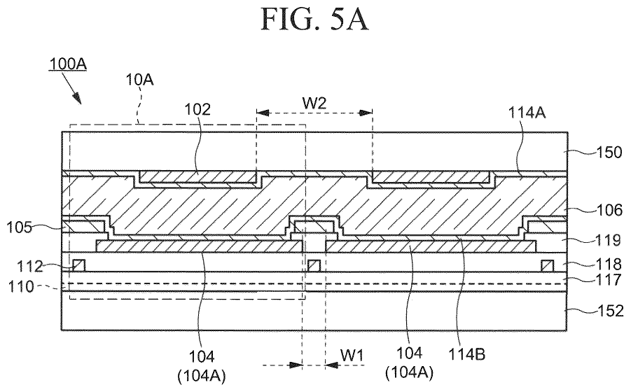

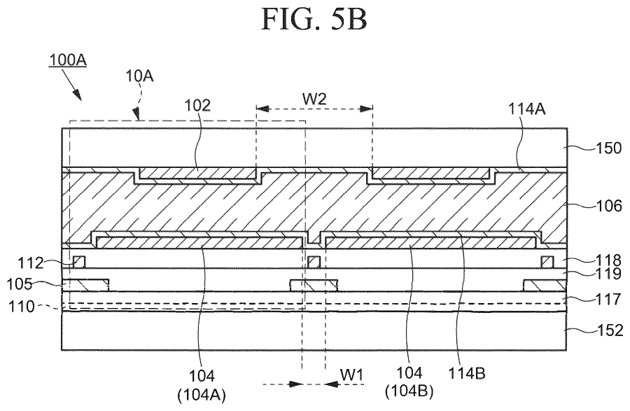

The arrangement of the auxiliary electrodes 105 is not limited to that shown in FIG. 1A and FIG. 1B. For example, as shown in FIG. 5A, the auxiliary electrode 105 may be disposed on an upper layer side (side of the liquid crystal layer 106) of the control electrodes 104 (first control electrode 104A, second control electrode 104B). In this structure, the third insulating layer 119 is arranged on the upper layer side of the control electrodes 104. The third insulating layer 119 is disposed with openings to cover the periphery of the first control electrode 104A and the second control electrode 104B and to expose the center portion. The auxiliary electrode 105 is arranged on the top surface of the third insulating layer 119.

FIG. 5B shows a structure in which the auxiliary electrode 105 is arranged on a lower layer of the second insulating layer 118. In this structure, the auxiliary electrode 105 is arranged closer to the second substrate 152 than the control signal line 112. The third insulating layer 119 is disposed between the auxiliary electrode 105 and the control signal line 112. FIG. 5B shows a structure in which the auxiliary electrode 105 is arranged to overlap the region between the first control electrode 104A and the second control electrode 104B, but the auxiliary electrode 105 may be disposed to spread over the entire surface of the second substrate 152. It is possible to form a single conductive surface in high-frequency terms, and form the reflector of the reflect array 100A by the arrangement of the auxiliary electrode 105 as shown in FIG. 5A and FIG. 5B, also by being arranged to overlap the control electrode 104.

As described above, the reflection array 100A according to the present embodiment has the patch electrode (common electrode) 102 disposed on the incident surface of the radio wave and is held at a constant potential, the electric field may not be disturbed by the control signal line 112 applied with the bias voltage, therefore, it is possible to accurately control the direction of travel of the reflected wave. Moreover, the auxiliary electrode 105 is disposed to fill the gap between the control electrode 104 arranged across the liquid crystal layer 106 at the back of the patch electrode (common electrode) 102, and it is possible to form one continuous reflector in high-frequency terms to sufficiently conduct a high-frequency current. As a result, the reflective characteristics of the reflect array 100A can be improved.

### Second Embodiment

This embodiment shows an example of a reflect array in which the structure of the patch electrode (common electrode) differs from the first embodiment. The following description will focus on the portions that differ from the first embodiment, and duplicated portions will be omitted as appropriate.

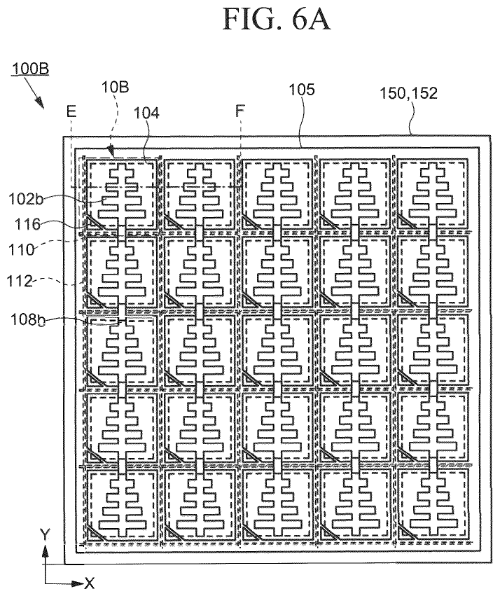

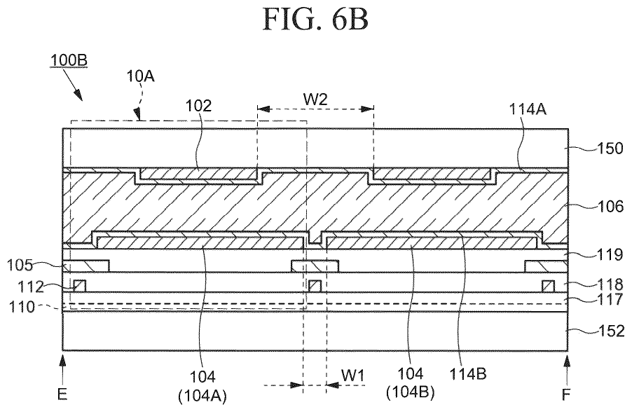

FIG. 6A shows a plan view of a reflect array 100B according to the second embodiment, and FIG. 6B shows a cross-sectional structure corresponding to the portion between E-F shown in the plan view. The reflect array 100B has a structure with the first substrate 150 and the second substrate 152, and a patch electrode (common electrode) 102B, the liquid crystal layer 106, the control electrode 104, and the auxiliary electrode 105 are stacked between these two substrates.

The reflect array 100B has a configuration in which a multiple resonance unit cell 10B is arranged in an array. The multiple resonance unit cell 10B has a different shape of the patch electrode (common electrode) 102b compared to the unit cell 10A shown in the first embodiment. The patch electrode (common electrode) 102b has a structure in which a plurality of parallel dipoles is arranged. The plurality of parallel dipoles has different lengths and different resonance frequencies. FIG. 6A shows a configuration in which four parallel dipoles of different lengths are arranged along the Y-axis direction. The length and number of parallel dipoles are arbitrary and can be set as desired.

The patch electrode (common electrode) 102b is connected by a common wiring 108b. In the first embodiment, the common wiring 108 is arranged in both the X-axis direction and the Y-axis direction, but in this embodiment, the common wiring 108b is arranged only in the Y-axis direction that intersects the parallel dipole. Although not shown in FIG. 6A, the common wiring 108b may be interconnected in the outer regions where the multiple resonance unit cells 10B are arranged. A constant potential (for example, a ground potential) is disposed to the common wiring 108b.

According to the present embodiment, the patch electrode (common electrode) 102b can be configured with a plurality of parallel dipoles to form the multiple resonance unit cell 10B. The reflect array 100B according to the present embodiment is the same as the reflect array 100A according to the first embodiment except for the different form of the patch electrode (common electrode) 102b, and the same effect can be obtained. That is, the auxiliary electrode 105 is disposed to fill the gap in the region where the control electrode 104 is arranged, which can compensate for the reduction in area as a reflector and improve the reflective characteristics. Furthermore, the reflect array 100B can significantly improve the bandwidth, phase range, and loss by configuring the reflect array 100B with multiple resonant unit cells 10B.

The various configurations of the reflect arrays illustrated as embodiments of the present invention may be combined as appropriate as long as they do not contradict each other. Based on the reflect arrays disclosed in this specification and the drawings, any addition, deletion, or design change of configuration elements, or any addition, omission, or change of conditions of a process by a person skilled in the art is also included in the scope of the present invention, as long as it has the gist of the invention.

Other advantageous effects different from the advantageous effects brought about by the mode of embodiment disclosed herein, which are obvious from the description herein or which can be easily foreseen by those skilled in the art, are naturally considered to be brought about by the present invention.

What is claimed is:

1. A reflect array comprising:
a plurality of patch electrodes arranged spaced apart and interconnected to an incident surface of a radio wave;
a plurality of control electrodes arranged spaced apart to correspond to the plurality of patch electrodes and disposed on a rear side of the plurality of patch electrodes;
a liquid crystal layer between the plurality of patch electrodes and the plurality of control electrodes; and
an auxiliary electrode disposed to overlap a separated region of the plurality of control electrodes.

2. The reflect array according to claim 1, wherein the auxiliary electrode is disposed in a separated region of the plurality of patch electrodes in a plan view.

3. The reflect array according to claim 1, further comprising an insulating layer between the plurality of control electrodes and the auxiliary electrode.

4. The reflect array according to claim 1, wherein the plurality of control electrodes are between the auxiliary electrode and the liquid crystal layer.

5. The reflect array according to claim 1, wherein the auxiliary electrode is between the plurality of control electrodes and the liquid crystal layer.

6. The reflect array according to claim 1, wherein a potential of the auxiliary electrode is grounded or floating.

7. The reflect array according to claim 1, further comprising:
an array substrate disposed with a plurality of control electrodes; and
a counter substrate disposed with a plurality of patch electrodes,
wherein
the liquid crystal layer is disposed between the array substrate and the counter substrate,
the plurality of control electrodes are each connected to a transistor and are individually controlled by an applied voltage, and
the auxiliary electrode is disposed on the array substrate.
